(19) United States
(12) Patent Application Publication
(10) Pub. No.: US 2021/0188040 A1
(43) Pub. Date: Jun. 24, 2021

(54) Auxiliary Air-Conditioning System for Over-the-Road Trucks

(71) Applicant: Frank Fierro, Midland, TX (US)

(72) Inventor: Frank Fierro, Midland, TX (US)

(21) Appl. No.: 17/196,591

(22) Filed: Mar. 9, 2021

Related U.S. Application Data
(63) Continuation-in-part of application No. 16/081,443, filed on Aug. 31, 2018, now Pat. No. 10,717,345.
(60) Provisional application No. 62/305,983, filed on Mar. 9, 2016.

(51) Int. Cl. B60H 1/00; B60H 1/22

(52) U.S. Cl. CPC B60H 1/00378; F24H 1/0018; B60H 1/2221; B60H 1/00428

(57) ABSTRACT

The invention relates to a system that is added to a standard vehicle installed air-conditioning system that allows the standard vehicle installed air-conditioning system to cool and condition the air inside the vehicle without operating the engine of the vehicle. This allows the vehicle to be air-conditioned without polluting the air via continuous operation of the vehicle's (usually) diesel engine. Also, a thermal heating tank is included to warm the electrical components of the system and to ensure improved morning starting of the vehicle's engine. Also, an interiorly operating alternator recaptures some of the energy generated by the system when the air conditioning compressor is disconnected from the electric motor that powers it, but the electric motor remains activated.

### CROSS-REFERENCE TO RELATED APPLICATIONS

This application takes priority from U.S. Prov. Pat. 62/305,983 filed Mar. 9, 2016, PCT Application No. PCT/US17/20944 filed Mar. 6, 2017, and, is a continuation-in-part of U.S. Pat. No. 10,717,345 all of which are incorporated in their entirety by reference.

### FIELD OF THE INVENTION

The present invention relates generally to the augmentation of standard vehicle installed air-conditioning systems. More specifically, the invention relates to a system that is added to a standard vehicle installed air-conditioning system that allows the standard vehicle installed air-conditioning system to cool and condition the air inside the vehicle without operating the engine of the vehicle. This allows the vehicle to be air-conditioned without polluting the air via continuous operation of the vehicle's (usually) diesel engine. Also, a thermal heating tank is included to warm the electrical components of the system and to ensure improved morning starting of the vehicle's engine.

### BACKGROUND OF THE INVENTION

Truck drivers haul thousands of pounds of materials thousands of miles every day. Due to state and federal regulations, these drivers can only log certain numbers of hours each day they are on the road. As a result, long-distance truck drivers often sleep in their trucks between service days. Naturally, they require air-conditioning during this off time. Accordingly, most truck drivers operate their main (or a smaller auxiliary) diesel engine simply to power the air-conditioner. Diesel engine technology is cleaner from an emissions point-of-view than it was years before, but it is still relatively dirty. What is needed then is a system that may be affixed to a standard over-the-road truck that allows the operator to limit the amount of time that his main (or auxiliary) diesel engine is running yet still use the air-conditioner as needed during off time between driving sessions. This is the goal of the present invention. Further, since the driver is expected to disable the vehicle's engine during overnight stays, the invention includes a thermal heating tank plumbed into the truck's cooling system. The thermal heating tank warms the invention's batteries and the truck's engine thus enabling smoother starts.

### SUMMARY OF THE INVENTION

According to one embodiment of the present invention, a system for allowing the operator of an over-the-road truck to operate the air-conditioner installed in the vehicle without the need of operating the truck's main (or auxiliary) internal combustion engine is disclosed.

According to one embodiment, the invention relates to an auxiliary air-conditioning system that: 1) Compresses Freon®; 2) Possesses a condensing coil, 3) Possesses an alternator; and, 4) Possesses an external thermal heating tank interoperating with the cooling system of the engine.

The auxiliary air-conditioning is installed in the standard air-conditioning system so that condensed, compressed refrigerant is injected into the standard vehicle installed air-conditioning system prior to the standard expansion valve in the vehicle installed air-conditioning system. Lower pressure, warmer refrigerant is collected from the standard vehicle installed air-conditioning system as it returns from the evaporator coil. This lower pressure, warmer refrigerant is re-pressurized and the cycle repeats.

The thermal heating tank is located in close proximity to the batteries contained in the invention and plays a role in securing their thermal stability. The thermal heating tank is also plumbed into the cooling system of the vehicle's main engine. The thermal heating tank also has an electrical heating element and a pump installed. Both the electrical heating element and the pump are wired to the battery of the invention. Through this arrangement, fluid in the electrical heating tank is warmed and pumped through the engine of the vehicle ensuring better starts even while the engine of the vehicle is disabled.

### BRIEF DESCRIPTION OF THE DRAWINGS

FIG. 1 shows a block diagram of a prior art air-conditioning system.

FIG. 2 shows a block diagram of one embodiment of the present invention used in concert with a prior art air-conditioning system.

FIG. 3 shows a block diagram of an additional embodiment of the present invention used in concert with a prior art air-conditioning system.

### DETAILED DESCRIPTION OF THE EMBODIMENTS

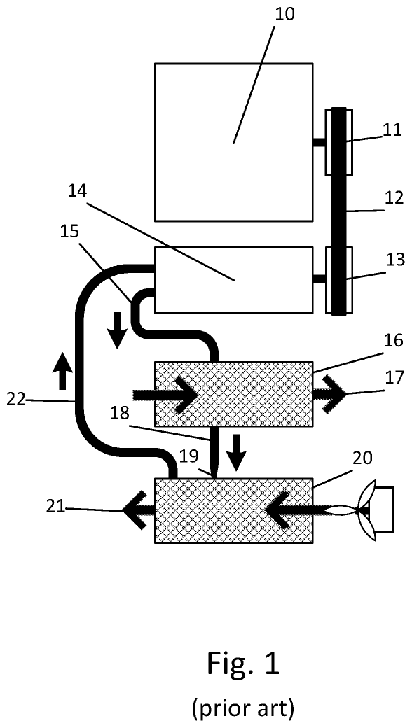

Referring now to FIG. 1, a block diagram of prior art vehicular mounted air-conditioning system is show. Standard vehicular compressor 14 is mechanically coupled to motor 10 by means of belt 12. Belt 12 runs in belt guides 11 and 13. Standard vehicular compressor 14 is energized as needed by means of a clutch in belt guide 13. Motor 10 is ordinarily the main motor of the vehicle. Such motors are powered by diesel, gasoline, LPG/LNG and so on. Alternately, motor 10 may be an accessory motor and may itself be electric.

Standard vehicular compressor 14 compresses the refrigerant. The refrigerant may be any chloro/fluorocarbon compound suitable for the task. Ordinarily, R134A is used in vehicles, but there are numerous other refrigerants currently deployed and/or under development and deployment. For example, HFO-1234yf is currently under wide deployment in vehicular air-conditioning systems. Also, R12, R152A, and R774 (or refrigerant grade CO₂) have been used.

Compressed R134A is under pressure and is hot. Hot, compressed R134A travels first to condensing coil 16. Ordinarily, condensing coil 16 is exposed to ambient air where ambient cooling air 17 flows through condensing coil 16 to cool the compressed coolant. Ambient cooling air 17 flows through condensing coil 16 naturally, by moving the condensing coil forward through the atmosphere, or, condensing coil 16 may stay fixed in the atmosphere and ambient cooling air 17 may be forced through condensing coil 16. Either way, compressed coolant is cooled from the hot state in which it is presented to condensing coil 16.

Cooled, compressed R134A travels next to transfer line 18 and expansion valve 19. Expansion valve 19 is a flow restricting device that causes a pressure drop in the cooled compressed R134A as cooled, compressed R134A travels through the expansion valve. Upon exiting expansion valve 19, the R134A is at lower pressure, gaseous, and cold. Simultaneously, the cold R134A gas flows into and through vehicular evaporator coil 20. Vehicular evaporator coil 20 is associated with an electrically powered blower and ambient air is blown through vehicular evaporator coil 20. By this means the warm ambient cooled occupant cabin air 21 is cooled while the R134A is heated and forms a warm gas. The warm low-pressure gaseous R134A is routed for recompression by standard vehicular compressor 14 by means of suction line 22.

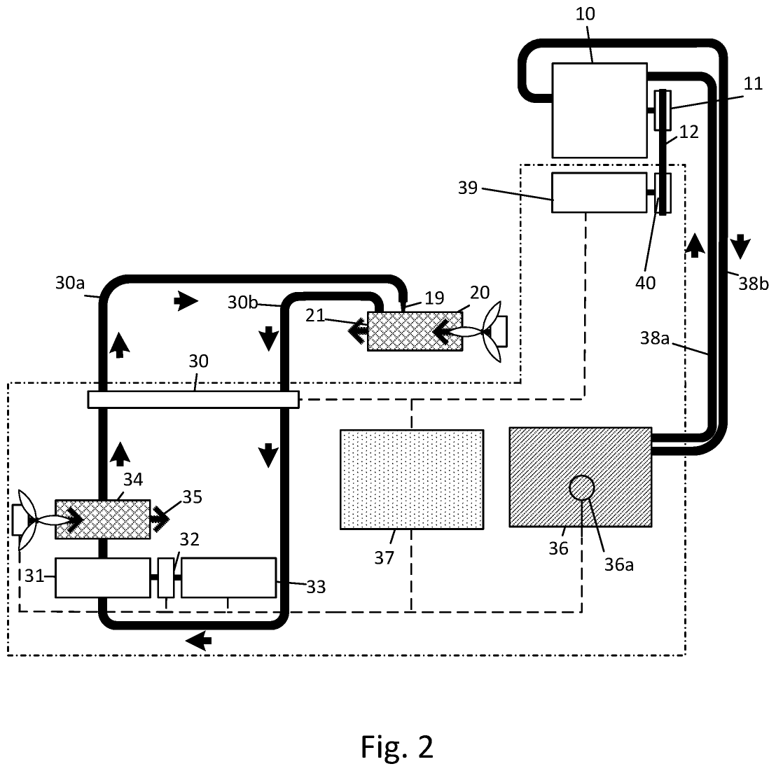

Referring now to FIGS. 1 and 2, one embodiment of the present invention is disclosed. This embodiment of the present invention is constructed to be integrated with a typical vehicular air-conditioner. In this embodiment of the invention, high-pressure line 30a is plumbed into the vehicular air-conditioning system on the high-pressure side of expansion valve 19. Similarly, low-pressure line 30b is plumbed into the vehicular air-conditioner on the low-pressure side of vehicular evaporator coil 20. Also, high-pressure (pumped) coolant line 38a is plumbed into the engine's cooling system at any arbitrary point. Finally, low-pressure coolant return line 38b is plumbed into the engine's coolant system at an arbitrary point thermally opposite the point where high-pressure (pumped) coolant line 38a is plumbed into the engine's cooling system.

Fluidic access for R134A to the invention is enabled by electric access valve 30. When the system is disabled, electric access valve 30 is closed, closing fluidic access by R134A in lines 30a and 30b. When the system is enabled, electric access valve 30 is open, opening fluidic access by R134A in lines 30a and 30b. Fluidic access for coolant to coolant tank 36 is always provided to the cooling system of the engine. As a result the fluid in coolant tank 36 achieves thermal equilibrium with the coolant as it circulates through the engine.

When electric access valve 30 is open, hot gaseous R134A in low-pressure line 30b is collected by the present invention and routed to compressor 31. Compressor 31 is powered by electric motor 33 by means of electric clutch 32. Hot gaseous R134A is compressed by compressor 31 and exits it as high-pressure, high temperature gaseous R134A. This is routed to condensing coil 34 where it travels through a heat exchanger where atmospheric air 35 is blown through condensing coil 34. This causes the conversion of the high-pressure, high temperature gas to high-pressure, low temperature liquid.

This high-pressure, low temperature liquid is routed through electric access valve 30 into high-pressure line 30a where it is injected into the vehicular air-conditioning system just prior to expansion valve 19. At expansion valve 19, the vehicular air-conditioning system functions as it does when pressurized R134A is created by standard vehicular compressor 14, i.e. the expansion valve causes a rapid reduction in pressure of the high-pressure, low temperature liquid R134A. When this happens, the high-pressure, low temperature liquid R134A evaporates and forms a lower pressure, lower temperature gas to flow through vehicular evaporator coil 20. The electric blower associated with vehicular evaporator coil 20 forces warm ambient occupant cabin air 21 through vehicular evaporator coil 20. This lowers the temperature of warm ambient occupant cabin air 21. The R134A then returns through electric access valve 30 to be compressed and used again.

The system is powered by battery 37. Battery 37 is wired to alternator 39. Alternator 39 replaces standard vehicular compressor 14 and serves to charge battery 37. It will be readily obvious that alternator 39 may be replaced by a conventional generator. Battery 37 is also wired to thermal heating element 36a inside coolant tank 36. Thermal heating element 36a is automatically activated to keep coolant in coolant tank 36 at a relatively constant temperature. Battery 37 also powers the pump used to circulate coolant from coolant tank 36 through motor 10 by means of high-pressure (pumped) coolant line 38a and low-pressure coolant return line 38b. Coolant tank 36 is physically associated with battery 37. This arrangement provides thermal stability to battery 37.

The disclosed embodiment of the invention is mounted on a tractor vehicle or other motorized commercial trucking platform. Ordinarily, the unit is mounted behind the cab of the tractor between the hitch of the tractor and the rear surface of the tractor. Accordingly, the unit is relatively tall and wide yet thin in the dimension from the back of the rear surface of the tractor towards the hitch. This thinness is provided so that the tractor can maneuver when towing a trailer.

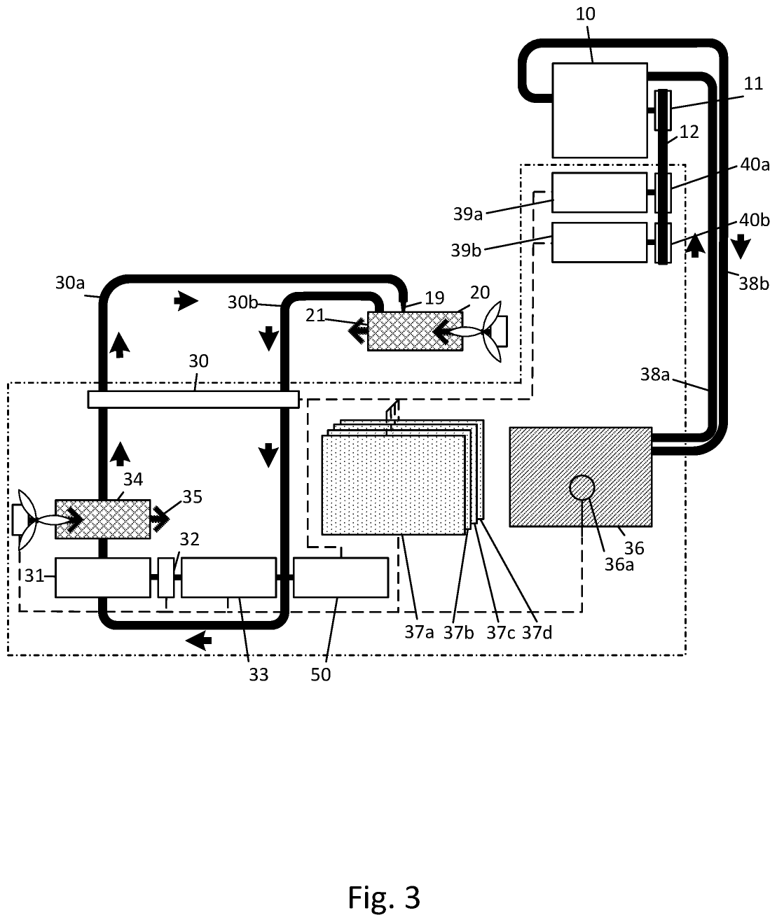

Referring now to FIGS. 1, 2, and 3 an additional embodiment of the present invention is disclosed. This embodiment of the present invention is constructed to be integrated with a typical vehicular air-conditioner. In this embodiment of the invention, high-pressure line 30a is plumbed into the vehicular air-conditioning system on the high-pressure side of expansion valve 19. Similarly, low-pressure line 30b is plumbed into the vehicular air-conditioner on the low-pressure side of vehicular evaporator coil 20. Also, high-pressure (pumped) coolant line 38a is plumbed into the engine's cooling system at any arbitrary point. Finally, low-pressure coolant return line 38b is plumbed into the engine's coolant system at an arbitrary point thermally opposite the point where high-pressure (pumped) coolant line 38a is plumbed into the engine's cooling system.

Fluidic access for R134A to the invention is enabled by electric access valve 30. When the system is disabled, electric access valve 30 is closed, closing fluidic access by R134A in lines 30a and 30b. When the system is enabled, electric access valve 30 is open, opening fluidic access by R134A in lines 30a and 30b. Fluidic access for coolant-to-coolant tank 36 is always provided to the cooling system of the engine. As a result, the fluid in coolant tank 36 achieves thermal equilibrium with the coolant as it circulates through the engine.

When electric access valve 30 is open, hot gaseous R134A in low-pressure line 30b is collected by the present invention and routed to compressor 31. Compressor 31 is powered by electric motor 33 by means of electric clutch 32. Hot gaseous R134A is compressed by compressor 31 and exits it as high-pressure, high temperature gaseous R134A. This is routed to condensing coil 34 where it travels through a heat exchanger where atmospheric air 35 is blown through condensing coil 34. This causes the conversion of the high-pressure, high temperature gas to high-pressure, low temperature liquid.

This high-pressure, low temperature liquid is routed through electric access valve 30 into high-pressure line 30a where it is injected into the vehicular air-conditioning system just prior to expansion valve 19. At expansion valve 19, the vehicular air-conditioning system functions as it does when pressurized R134A is created by standard vehicular compressor 14, i.e. the expansion valve causes a rapid reduction in pressure of the high-pressure, low temperature liquid R134A. When this happens, the high-pressure, low temperature liquid R134A evaporates and forms a lower pressure, lower temperature gas to flow through vehicular evaporator coil 20. The electric blower associated with vehicular evaporator coil 20 forces warm ambient occupant cabin air 21 through vehicular evaporator coil 20. This lowers the temperature of warm ambient occupant cabin air 21. The R134A then returns through electric access valve 30 to be compressed and used again.

The system is powered by a multiplicity of batteries 37a, 37b, 37c, and 37d. Batteries 37a, 37b, 37c, and 37d are wired to alternators 39a and 39b. Alternators 39a and 39b occupy the space formerly occupied by the standard vehicular compressor 14 and serve to charge batteries 37a, 37b, 37c, and 37d. It will be readily obvious that alternators 39a and 39b may be replaced by conventional generators. Batteries 37a, 37b, 37c, and 37d are also wired to thermal heating element 36a inside coolant tank 36. Thermal heating element 36a is automatically activated to keep coolant in coolant tank 36 at a relatively constant temperature. Batteries 37a, 37b, 37c, and 37d also power the pump used to circulate coolant from coolant tank 36 through motor 10 by means of high-pressure (pumped) coolant line 38a and low-pressure coolant return line 38b. Coolant tank 36 is physically associated with batteries 37a, 37b, 37c, and 37d. This arrangement provides thermal stability to batteries 37a, 37b, 37c, and 37d.

This embodiment of the invention may be equipped an integral interiorly operating alternator 50 (or a conventional generator) such that when electric clutch 32 is disengaged from compressor 31 but electric motor 33 is transiently activated the rotational energy generated by electric motor 33 is partially converted back to electric energy and stored in batteries 37a, 37b, 37c, and 37d. By this means the some of the energy transiently generated by electric motor 33 and not used to power compressor 31 is recaptured and stored in batteries 37a, 37b, 37c, and 37d.

It will be obvious to those having skill in the art that any number of batteries (including one) may be substituted for batteries 37a, 37b, 37c, and 37d. Similarly, any number of alternators (including one) may be substituted for alternators 39a and 39b. Similarly, it will be obvious to one having skill in the art that the system may be operated using alternating current (AC) or direct current (DC) at any conventional voltage.

The disclosed embodiment of the invention is mounted on a tractor vehicle or other motorized commercial trucking platform. Ordinarily, the unit is mounted behind the cab of the tractor between the hitch of the tractor and the rear surface of the tractor. Accordingly, the unit is relatively tall and wide yet thin in the dimension from the back of the rear surface of the tractor towards the hitch. This thinness is provided so that the tractor can maneuver when towing a trailer. Similarly, the unit may be mounted on the step side of the cab unit.

1. An auxiliary air-conditioning system for over-the-road trucks comprising:
a. more than one battery;
b. at least one alternator driven by the associated vehicle's engine;
c. a condensing coil with electric fan;
d. a compressor compressing refrigerant driven by an electric motor by means of a coupling;
e. an electric access valve with a high-pressure output port and a low-pressure input port;
f. a coolant tank with integral electric heating element and pump;
g. wherein the more than one battery powers the electric access valve, the electric motor, the coupling, the electric fan, the electric heating element, and the pump;
h. wherein the more than one battery is configured to be charged by the at least one alternator when the associated vehicle's engine is running;
i. wherein the refrigerant output of the compressor flows through the condensing coil and out of the auxiliary air-conditioning system via the high-pressure port of the electric access valve whereupon it is then injected into a vehicular installed air-conditioning system just upstream of the expansion valve;
j. wherein the refrigerant input to the auxiliary air-conditioning system is collected just downstream of the evaporator coil of the vehicular installed air-conditioning system and flows via the low-pressure port of the electric access valve through the internal heat exchanger in the cooling water tank and into the compressor;
k. wherein the output of the pump flows from the coolant tank into the cooling system of the associated vehicle's engine;
l. wherein the input of the coolant tank receives coolant from the associated vehicle's engine.

2. An auxiliary air-conditioning system of claim 1 in which the refrigerant is R134A.

3. An auxiliary air-conditioning system of claim 1 in which the refrigerant is HFO-1234yf.

4. An auxiliary air-conditioning system of claim 1 in which the coolant tank and the at least one battery are physically coupled such that the coolant tank provides thermal stability to the at least one battery.

5. An auxiliary air-conditioning system of claim 1 in which the output of the pump flows from the coolant tank to the cooling system of the associated vehicle's engine such that the coolant provides thermal stability to the cooling system of the associated vehicle's engine.

6. An auxiliary air-conditioning system of claim 1 in which the output of the pump flows from the coolant tank to the cooling system of the associated vehicle's engine such that the vehicle's engine starts more easily when it is cold.

7. An auxiliary air-conditioning system of claim 1 in which the rotational output of the electric motor powers an interiorly operating alternator such that when the electric motor is operational, but the compressor is disengaged from the electric motor by means of the coupling, the rotational energy of the electric motor powers the interiorly operating alternator such that some of the transient rotational energy of the electric motor is recaptured and stored in the at least one battery.
